(19) United States
(12) Patent Application Publication
(10) Pub. No.: US 2015/0274216 A1
(43) Pub. Date: Oct. 1, 2015

(54) SKID PLATE ASSEMBLY FOR AXLE HOUSING OF MACHINE

(71) Applicant: CATERPILLAR INC., PEORIA, IL (US)

(72) Inventor: Bryan Dale Van Dyke, MT. ZION, IL (US)

(73) Assignee: CATERPILLAR INC., PEORIA, IL (US)

(21) Appl. No.: 14/228,315

(22) Filed: Mar. 28, 2014

(51) Int. Cl. B62D 25/20; B60R 19/02

(52) U.S. Cl. CPC B62D 25/2072; B60R 19/02

(57) ABSTRACT

A skid plate assembly for an axle housing of a machine is disclosed. The skid plate assembly includes a skid plate, at least one gusset member, and a hitch member. The skid plate includes an impact side and a mount side. The at least one gusset member includes an attachment portion and an impact portion. The attachment portion is integrally attached to the mount side of the skid plate. The impact portion is positioned to overlay the axle housing, when the skid plate is in an assembled position. The hitch member includes a first end and a second end. The first end is fixable to the axle housing and the second end removeably retains the skid plate. Further, the impact portion of the gusset member transfers the impact force to the axle housing in response to an impact to the impact side of the skid plate.

### TECHNICAL FIELD

The present disclosure generally relates to protection of undercarriage or under-bellies of machines. More specifically, the present disclosure relates to a removable skid plate assembly for a machine.

### BACKGROUND

Most machines, such as an earthmoving machine, include at least one axle assembly and more commonly two. The front axle assembly may include components such as, but are not limited to, an axle housing, an axle, a suspension system, steering cylinders, hoses, and/or wheel-end component systems. Proper functioning of any or all the components of the axle assembly is important for the overall proper functioning of the machine. However, when the machine works in a hostile environment, such as a construction site, mine site or any other harsh terrain condition, it is common for one or both axle assemblies to experience impacts with objects which are generally part of salient terrain conditions. Such impacts may damage the axle assembly and/or one or more components mentioned above. This damage may debilitate the machine and/or may reduce the efficiency and productivity of the machine.

It is known to apply a fixed guard, typically in the form of an iron member welded, bolted or otherwise permanently fixed to the axle to protect the axle assembly from impact with objects. However, in some instances a front axle assembly is even more vulnerable to impact since it may include additional components attached thereto such as steering cylinders, hydraulic hoses and linkage members. For example when a motor grader is in operation it is often used to create a row of rock and dirt as a first pass is carried out by the motor grader during a road grading operation within a work-site. It is common for the motor grader, during a subsequent pass to impact the row of rock and dirt, usually the impact is experienced in an area corresponding to the center portion of the front axle. This may result in damage to the front axle and associated components and cause machine downtime.

Currently, a plate or guard is uniquely fabricated and custom fit by welding or permanently fixing to the axle assembly. Custom guards add cost to the machine and may not provide full protection for the axle. Custom guards may also create problems for service personnel requiring access to the axle during a service event.

The present disclosure is directed towards overcoming one or more of the above-stated challenges.

### SUMMARY OF THE DISCLOSURE

In the current disclosure, a skid plate assembly for use with an axle housing is disclosed. The skid plate assembly includes a skid plate, at least one gusset member, and a hitch member. The skid plate further includes an impact side and a mount side. The gusset member includes an attachment portion and an impact portion. The attachment portion of the gusset member is integrally attached to the mount side of the skid plate. The impact portion of the gusset member is positioned to overlay the axle housing when the skid plate is in an assembled position. The hitch member includes a first end and a second end. The first end is fixable to the axle housing. The second end removeably retains the skid plate. Further, the impact portion of the gusset member transfers the impact force to the axle housing in response to an impact to the impact side of the skid plate.

Other features and advantages of the disclosure will become apparent to those skilled in the art, upon review of the following detailed description and drawings.

### BRIEF DESCRIPTION OF DRAWINGS

FIG. 1 illustrates a perspective view of an exemplary machine fitted with a skid plate assembly in accordance with the concepts of the present disclosure;

FIG. 2 illustrates an enlarged perspective view of a front axle assembly of the machine shown in FIG. 1, illustrating the skid plate assembly in accordance to the concepts of the present disclosure;

FIG. 3 illustrates a sectional view of the front axle assembly along line 3-3 of FIG. 2, illustrating the center gusset and gap between the gusset and the axle housing; and

FIG. 4 illustrates a perspective view of the front axle assembly with the skid plate assemblies in accordance to the concepts of the present disclosure.

### DETAILED DESCRIPTION

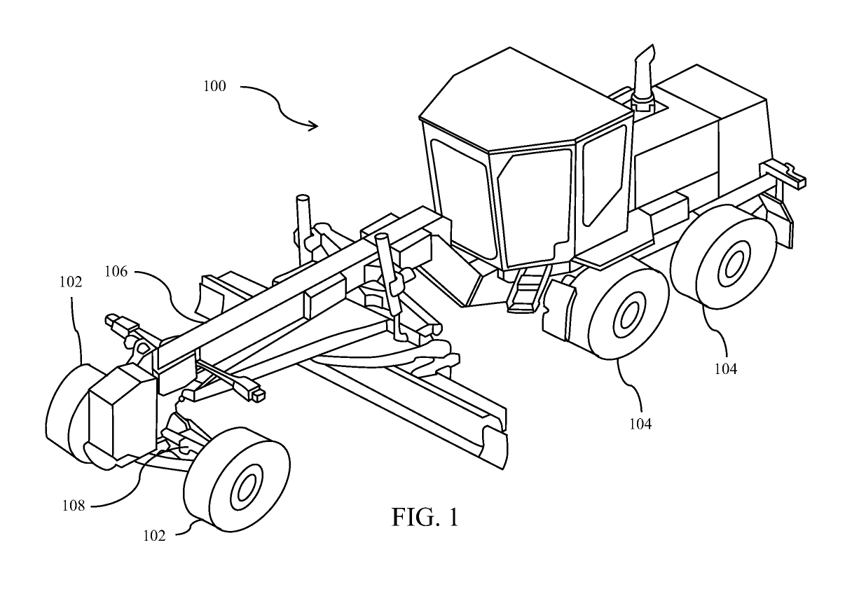

Referring to FIG. 1, an exemplary machine 100 is shown and may be of the type that performs various operations associated with an industry such as, but not limited to mining, construction, farming, or transportation industry. The machine 100 is depicted as a motor grader however may alternatively be an earth moving machine such as a hydraulic excavator, a wheel loader, a shovel, a backhoe loader, a truck or any other construction or earth moving machine.

The machine 100 includes a set of front wheels 102, rear wheels 104, a frame 106, and a front axle assembly 108. The frame 106 supports mechanical components and electrical components of the machine 100. The set of front wheels 102 may be rotatably supported by the front axle assembly 108 and the front axle assembly 108 may be mounted to the frame 106.

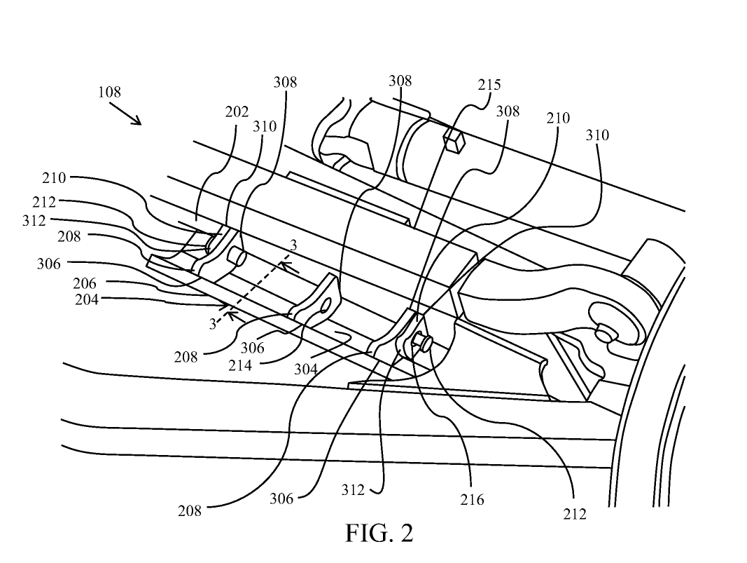

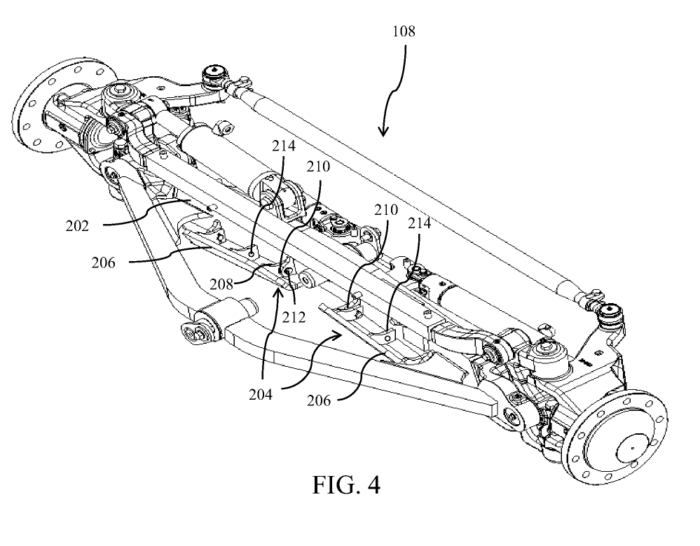

Referring to FIG. 2, the front axle assembly 108 includes an axle housing 202 and a skid plate assembly 204. The axle housing 202 rotatably supports the set of front wheels 102 and/or the set of rear wheels 104 of the machine 100 on each end (FIG. 4). The axle housing 202 further support components, such as, but not limited to, a brake oil supply line, a hydraulic supply line, electric wiring or sensors, and/or a plurality of bushings and sealing gaskets. The skid plate assembly 204 is retained relative to the front axle assembly 108 of the machine 100 as will be explained further below.

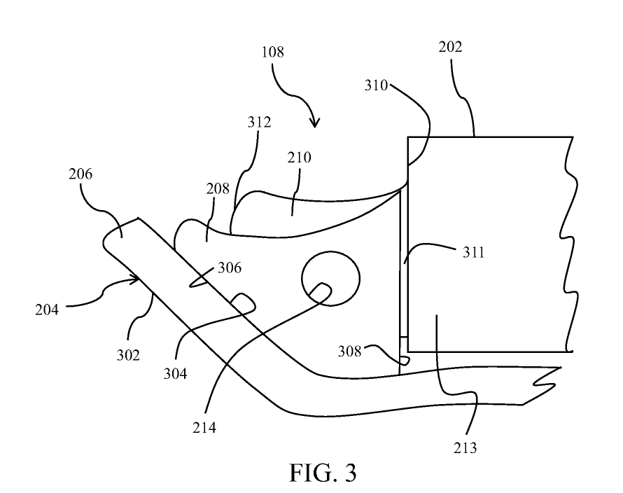

The skid plate assembly 204 is positioned at a lowermost portion 213 (FIG. 3) of the axle housing 202. In an exemplary embodiment, the skid plate assembly 204 is positioned in such a way that there is a pre-defined gap (FIG. 3) between the skid plate assembly 204 and the axle housing 202. The skid plate assembly 204 protects the front axle assembly 108 against damage due to an impact of an obstacle. The obstacle may be a rock, debris, and/or the like. The skid plate assembly 204 includes a skid plate 206, gusset members 208, hitch members 210 and lock pins 212.

Referring to FIG. 3 the skid plate 206 includes an impact side 302 and a mount side 304. The impact side 302 is a surface of the skid plate 206 facing the direction of motion of the machine 100. The mount side 304 is a surface of the skid plate 206 facing the front axle assembly 108, when mounted on the axle housing 202.

In an exemplary embodiment, the skid plate 206 is a one piece structure having a pre-defined thickness and length, such as for example a thickness of 19 mm. The skid plate 206 is thick enough to resist the force due to the impact. The skid plate 206 is long enough to cover a front face, a bottom face, and a rear face of the front axle assembly 108, and extends there-through. A first end 310 of the skid plate 206 is angled or bent in such a way that it rises up in a direction toward the front of the machine to cover the front face of the front axle assembly 108. The skid plate 206 is mounted to the axle housing 202 through the hitch members 210 (FIG. 2) as is described below

Referring again to FIGS. 2-3, each gusset member 208 includes an attachment portion 306 and an impact portion 308. The attachment portion 306 of each gusset member 208 is integrally attached, perhaps through a welding process, to the mount side 304 of the skid plate 206. Alternatively the gusset members 208 may be attached to the skid plate 206 using a threaded fastener, rivet joint or any other attachment technique known to those of ordinary skill in the art. Further, each gusset member 208 includes a through-hole 214 between the attachment portion 306 and the impact portion 308. In an exemplary embodiment, the skid plate assembly 204 includes 3 identical gusset members 208 however the center gusset 208 may not include the through-hole 214. It is envisioned that when selecting the optimum number of gusset members 208 for different size axle housings 202, the number of gussets will depend at least in part on the structure and size of the front axle assembly 108.

As best shown in FIG. 2, the skid plate assembly 204 attaches in a retaining type of relationship with the axle housing 202 through a pair of hitch members 210. Each hitch member 210 includes a first end 310 and a second end 312. The first end 310 of each hitch member 210 is fixable to the axle housing 202, though a welding process for example although other forms of permanent attachment known to those of ordinary skill in the art is also contemplated. The second end 312 of each hitch member 210 extends outwardly from the first end 310 of each hitch member 210 and includes a through-hole 216 to receive a lock pin 212 there through to retainably attach the skid plate assembly 204 to the axle housing 202. Each hitch member 210 includes the through-hole 216 located between the first end 310 and the second end 312 of the hitch member 210. In an exemplary embodiment, the hitch member 210 is a solid metallic bracket or plate and is attached to the axle housing 202 through a welding process for example. Alternatively, it is envisioned that each hitch member 210 could be a raised portion such as a boss built into the axle housing 202.

Referring to FIG. 4, shown are two skid plate assemblies 204 positioned at a lower portion 213 (FIG. 3) of the axle housing 202 and the through-holes 214 of each pair of the gusset member 208 of each skid plate assembly 204 aligns with the associated through-holes 216 of each pair of the hitch members 210 to receive the pair of lock pins 212 there through to retainably pin each skid plate assembly 204 to the axle housing 202. In FIG. 4 the center gusset of each skid plate assembly 204 is shown with through-holes 214 and are manufactured as such to minimize the different types of gussets required per assembly although it is envisioned that the center gusset may lack the through hole and consist of a continuous member. With the through-holes 216 of each pair of hitch members 210 being aligned with the respective pair of through-holes 214 in pair of gusset members 208, the lock pins 212 extend through the said aligned through-holes (214 & 216) and retainably connects the two end gusset members 208 with each associated hitch member 210, and as a result the pair of skid plate assemblies 204 are retainably connected with the axle housing 202. It will be understood that a clearance (not shown) between each lock pin 212 and the corresponding through-hole 216 in the hitch member 210 will be greater than the gap 311 between each impact portion 308 of the gusset member 208 to ensure that the force of impact on the impact side 302 of the skid plate 206 is distributed to the axle housing 202 through the impact portion 308 of the gusset member 208 and not through the lock pins 212 and associated hitch members 210.

### INDUSTRIAL APPLICABILITY

In operation, the machine 100 is used for various applications, such as surface mining, the construction industry, and the like. During such operations, the machine 100 may be subjected to hostile conditions, which may include rough terrain, debris, and rocks. This terrain may include objects that create a threat of damage or harm to the front axle assembly 108, or associated components if the machine were to strike or impact such object without the skid plate assembly 204 according to the present disclosure. In contrast, with the skid plate assemblies 204 installed, there is little or no threat of damage to the axle when the machine approaches and even strikes the object.

In an exemplary embodiment, the skid plate assembly 204 includes the skid plate 206 and three gusset members 208 on each end of the axle housing 202 (FIG. 4). Each skid plate assembly 204 attaches to the pair of hitch members 210 fixed to the axle housing 202. The impact portion 308 of each gusset member 208 is positioned to overlay the axle housing 202 when the skid plate assembly 204 is mounted on the axle housing 202. The impact portions 308 transfer impact force to the axle housing 202 in response to an impact to the impact side 302 of the skid plate 206. Therefore, the gusset members 208 directly transfer the force of impact to the axle housing 202 with minimum force getting transferred to the lock pins 212. Thus, preventing the failure of the lock pin 212. Further, it is envisioned that the present disclosure skid plate assembly 204 may include a skid plate 206 configuration that continuously extends along the bottom face and the rear face of the front axle assembly 108, thus forming a generally U-shaped skid plate member (not shown) and it is further envisioned that there may be additional hitch members 210 fixed to a backside face 215 (FIG. 2) of the axle housing 202 to align with identical skid plate assemblies (not shown) which are retainably attached to the backside face 215 through additional hitch members 210 (not shown) aligned with gusset members 208 (not shown) and lock pins 212 (not shown) there through in an identical fashion as that explained relative to skid plate assembly 204 being retainably attached to the front face of axle housing 202. The skid plate assemblies 204 may be easily attached or removed from the machine 100, during assembly, serviceability or a retro-fit process by simply removing each of the two lock pins 212 for removal of each skid plate assembly 204.

The present invention discloses a cost-effective method to solve the long existed problem that can be easily manufactured by readily available metal pieces. Also, this invention can be extended as an optional attachment to the already sold machines, as a solution for retro-fit or after sales market.

It should be understood that the above description is intended for illustrative purposes only and is not intended to limit the scope of the present disclosure in any way. Thus, those skilled in the art will appreciate that other aspects of the disclosure can be obtained from a study of the drawings, the disclosure, and the appended claim.

What is claimed is:

1. A skid plate assembly for use with an axle housing, wherein the skid plate assembly comprising:
a skid plate including an impact side and a mount side;
at least one gusset member, the gusset member having an attachment portion and an impact portion, the attachment portion of the gusset member being integrally attached to the mount side of the skid plate and the impact portion of the gusset member being positioned to overlay the axle housing when the skid plate is in an assembled position; and
a hitch member having a first end fixable to the axle housing and a second end configured to removeably retain the skid plate;
wherein the impact portion of the gusset member is configured to transfer impact force to the axle housing in response to an impact to the impact side of the skid plate.
